(19) United States
(12) Patent Application Publication
(10) Pub. No.: US 2009/0220287 A1
(43) Pub. Date: Sep. 3, 2009

(54) IMAGE FORMING APPARATUS AND RECORDING MEDIA CONVEYING METHOD FOR IMAGE FORMING APPARATUS

(75) Inventors: Yoshiaki Okano, Shizuoka (JP); Noboru Furuyama, Shizuoka (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/391,280

(22) Filed: Feb. 24, 2009

Related U.S. Application Data
(60) Provisional application No. 61/032,376, filed on Feb. 28, 2008.

(51) Int. Cl. G03G 15/20

(52) U.S. Cl. 399/322; 399/400

(57) ABSTRACT

An inlet guide having, on a recording media contact surface thereof, plural ribs inclining to a further inner side farther toward a recording media conveying direction is arranged upstream in a recording media conveying direction of a nip formed by a fixing roller and a pressing roller for heating and pressing a recording medium having a developer transferred thereon and the recording medium is brought into contact with the ribs of the inlet guide to guide the recording medium to the nip. The plural ribs are arranged such that an acute angle formed by center lines in a longitudinal direction of the plural ribs and a straight line parallel to a center line in width direction of a recording medium to be conveyed is equal to or larger than 5° and equal to or smaller than 20°.

### CROSS-REFERENCE TO RELATED APPLICATION

This application is based upon and claims the benefit of priority from the prior U.S.A. Patent Application No. 61/032,376, filed on 28th Feb., 2008, the entire contents of which are incorporated herein by reference.

### TECHNICAL FIELD

The present invention relates to image forming apparatuses such as a copying machine and a printer, and, more particularly to an image forming apparatus in which occurrence of gloss unevenness in recording media is reduced and a recording media conveying method for the image forming apparatus.

### BACKGROUND

An image forming apparatus such as a copying machine or a printer transfers a developer such as a toner onto a recording medium. The image forming apparatus includes a heating and fixing device that presses the recording medium, on which the developer is placed, while heating the recording medium. The image forming apparatus includes an inlet guide provided not to come into contact with a fixing roller and a pressing roller forming a nip of the heating and fixing device. The inlet guide guides the recording medium, on which the developer is placed, to the heating and fixing device.

An inlet guide in the past is formed by, for example, winding a PFA tape around the surface of a stainless steel plate (see, for example, JP-A-2008-241843). Therefore, in the inlet guide in the past, a surface that comes into contact with a recording medium is a plane.

However, a very small amount of a developer on a transfer belt may adhere to a transfer roller. The very small amount of the developer adheres to the inlet guide via a non-printing surface of the recording medium. Therefore, rear soiling may occur.

In order to solve this problem, JP-A-2004-157462 discloses a technique for providing ribs on a surface of an inlet guide that comes into contact with a recording medium.

However, when a large number of sheets are printed, the ribs are heated, some part of a developer tends to be melted by the heat, and gloss unevenness occurs.

### SUMMARY

It is an object of the present invention to provide an image forming apparatus in which occurrence of gloss unevenness in recording media is reduced and a recording media conveying method for the image forming apparatus.

In an aspect of the present invention, an image forming apparatus includes:

an image forming unit that forms a developer image on an image bearing member;

a transfer unit that transfers the developer image onto a recording medium;

a heating and fixing device that fixes the developer image, which is transferred onto the recording medium by the transfer unit, on the recording medium; and

an inlet guide that is arranged upstream in a recording media conveying direction of a nip formed by a fixing roller and a pressing roller of the heating and fixing device and has, on a recording media contact surface thereof, plural ribs inclining to a further inner side farther toward a recording media conveying direction.

### DESCRIPTION OF THE DRAWINGS

FIG. 1 is a diagram of a configuration example of an image forming apparatus;

FIG. 2 is a diagram of a position of an inlet guide;

FIG. 3 is a top view of the inlet guide;

FIG. 4 is a sectional view of the inlet guide taken along an A-A line in FIG. 3;

FIG. 5 is a sectional view of the inlet guide taken along a B-B line in FIG. 3; and

FIG. 6 is a table of ranges of a tilt angle θ of ribs.

### DETAILED DESCRIPTION

Throughout this description, the embodiments and examples shown should be considered as exemplars, rather than limitations on the apparatus and methods of the present invention.

An image forming apparatus and a recording media conveying method for the image forming apparatus according to an embodiment of the present invention are explained in detail below with reference to the accompanying drawings.

Overview of the Image Forming Apparatus

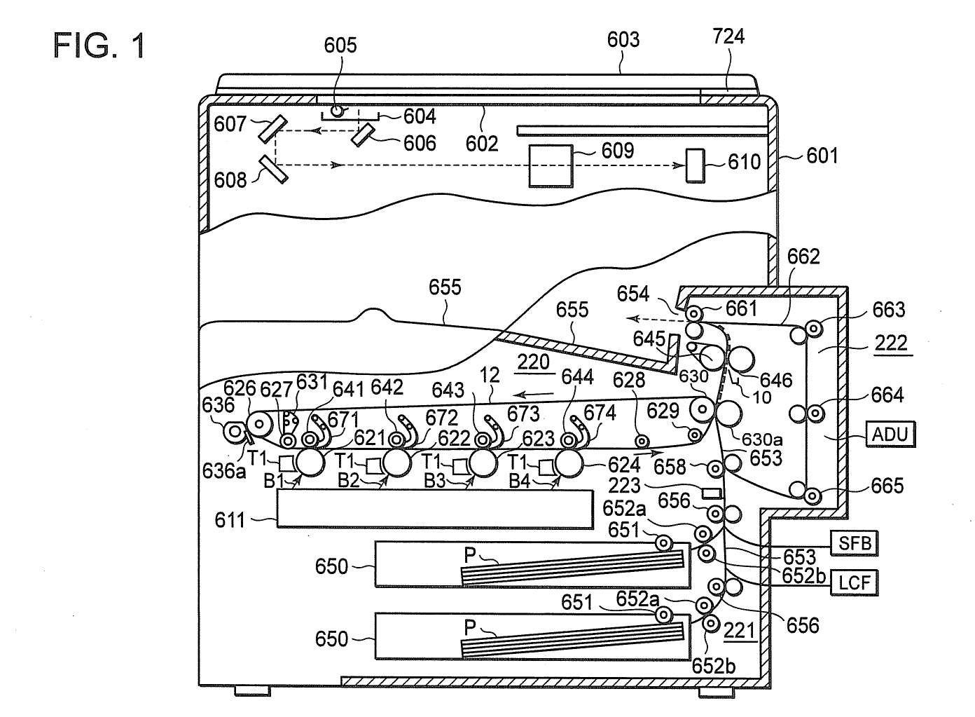

FIG. 1 is a diagram of a configuration example of the image forming apparatus. As shown in FIG. 1, the image forming apparatus includes an original table 602 for original placement which is made of a transparent material such as a glass plate, in an upper part of an apparatus main body 601. In the image forming apparatus, a cover 603 is openably and closably provided in the apparatus main body 601 to cover the original table 602.

The image forming apparatus includes, on a lower surface side of the original table 602 in the apparatus main body 601, a scan unit (not shown) that optically scans an image of an original placed on the original table 602. For example, this scan unit includes a carriage 604, reflection mirrors 606, 607, and 608 that reflect light of an exposure lamp 605 reflected on the original, a magnification lens block 609 that magnifies the reflected light, and a CCD (Charge Coupled Device) 610. The carriage 604 includes the exposure lamp 605 that irradiates light to the original table 602. The image forming apparatus includes the carriage 604 such that the carriage 604 can reciprocatingly move along the lower surface of the original table 602.

The carriage 604 moves forward while causing the exposure lamp 605 to light to expose the original placed on the original table 602. The CCD 610 receives a reflected light image of the original on the original table 602 formed by the exposure via the reflection mirrors 606, 607, and 608 and the magnification lens block 609. The CCD 610 outputs image data corresponding to the received reflected light image of the original.

The image forming apparatus includes an image forming unit 220 below the scan unit in the apparatus main body 601. The image forming unit 220 includes, for example, a print engine (not shown) and a process unit (not shown).

The print engine includes an exposing unit 611. The process unit includes photoconductive drums 621, 622, 623, and 624 serving as image bearing members located along the exposing unit 611, an endless transfer belt 12 located in a position opposed to the exposing unit 611 across the photoconductive drums 621, 622, 623, and 624, a drive roller 626 that drives the transfer belt 12, primary transfer rollers 641, 642, 643, and 644 located in positions opposed to the photoconductive drums 621, 622, 623, and 624 across the transfer belt 12, and a transfer roller driving unit that drives the primary transfer rollers 641, 642, 643, and 644.

In the image forming apparatus, the transfer belt 12 is laid over the drive roller 626, guide rollers 627, 628, and 629, and a driven roller 630. The transfer belt 12 receives power from the drive roller 626 and rotationally travels in the counterclockwise direction.

In the image forming apparatus, the guide roller 627 is provided to freely move up and down. The guide roller 627 receives pivotal movement of a cam 631 and moves to the transfer belt 12 side. The guide roller 627 displaces the transfer belt 12 to the photoconductive drums 621, 622, 623, and 624 side.

The image forming unit 220 executes an image forming process for forming an image based on image data (an image signal outputted from the CCD 610) and printing the image on a recording medium being conveyed. The image signal outputted by the CCD 610 is inputted to the exposing unit 611 after being appropriately processed. The exposing unit 611 emits a laser beam B1 corresponding to a yellow image signal to the photoconductive drum 621 for yellow, emits a laser beam B2 corresponding to a magenta image signal to the photoconductive drum 622 for magenta, emits a laser beam B3 corresponding to a cyan image signal to the photoconductive drum 623 for cyan, and emits a laser beam B4 corresponding to a black image signal to the photoconductive drum 624 for black.

The primary transfer rollers 641, 642, 643, and 644 move (fall) to the transfer belt 12 side to thereby bring the transfer belt 12 into contact with the photoconductive drums 621, 622, 623, and 624 and transfer visible images on the photoconductive drums 621, 622, 623, and 624 onto the transfer belt 12.

In the image forming apparatus, a drum cleaner, a charge removing lamp, and a charging unit, which are not shown in the figure, and a developing unit T1 are provided in order around the photoconductive drum 621. The drum cleaner has a drum cleaning blade that is set in contact with the surface of the photoconductive drum 621. The drum cleaner scrapes off, with the drum cleaning blade, a developer remaining on the surface of the photoconductive drum 621.

The charge removing lamp removes charges remaining on the surface of the photoconductive drum 621. The charging unit applies high voltage to the photoconductive drum 621 to thereby charge the surface of the photoconductive drum 621 with electrostatic charges. The exposing unit 611 irradiates the laser beam B1 on the charged surface of the photoconductive drum 621. An electrostatic latent image is formed on the surface of the photoconductive drum 621 by the irradiation of the laser beam B1. The developing unit T1 supplies a yellow developer (toner) to the surface of the photoconductive drum 621 to thereby visualize the electrostatic latent image on the surface of the photoconductive drum 621.

In the same manner, electrostatic latent images on the surfaces of the other photoconductive drums 622, 623, and 624 are respectively visualized by using developers of colors corresponding to the photoconductive drums 622, 623, and 624.

The image forming apparatus includes a cleaner 636 in a position opposed to the drive roller 626 of the image forming unit 220 across the transfer belt 12. The cleaner 636 has a cleaning blade 673a that is set in contact with the transfer belt 12. The cleaner 636 scrapes off, with the cleaning blade 673a, a developer remaining on the transfer belt 12.

Printing modes are changed as explained below. The image forming apparatus includes hooks 671, 672, 673, and 674 near the primary transfer rollers 641, 642, 643, and 644. The hooks 671, 672, 673, and 674 engage with shafts of the primary transfer rollers 641, 642, 643, and 644 and lift the shafts while pivoting and move the primary transfer rollers 641, 642, 643, and 644 in a direction away from the photoconductive drums 621, 622, 623, and 624. Printing modes such as a full-color mode, a total separation mode, and a monochrome mode are changed by not moving all of the primary transfer rollers 641, 642, 643, and 644 or changing a combination of the primary transfer rollers to be moved.

A storing mechanism and a feeding mechanism for recording media are explained below. The image forming apparatus includes plural recording media cassettes 650, which store recording media, below the exposing unit 611. These recording media cassettes 650 store, in a stacked state, a large number of recording media P of types different from one another. The image forming apparatus includes, respectively in outlet sections (on the right side in the figure) of the recording media cassettes 650, recording media feeding mechanisms 221 that feed the recording media in the recording media cassettes 650 one by one from the top. Each of the recording media feeding mechanisms 221 takes out the recording media P one by one from one of the recording media cassettes 650 corresponding thereto. The recording media feeding mechanism 221 for taking out the recording media P includes a pickup roller 651, a recording media feeding roller 652a, and a separation roller 652b. The recording media feeding mechanism 221 separates the recording media P, which are taken out from the recording media cassette 650, one by one and feeds the recording media P to a recording media conveying mechanism 653.

A conveying path for the recording media is explained below. The recording media conveying mechanism 653 extends to a recording media discharge port 654 in an upper part through the driven roller 630 of the image forming unit 220. The recording media discharge port 654 faces a recording media discharge section 655 that continues to an outer peripheral surface of the apparatus main body 601. The image forming apparatus includes, on a start end side of the recording media conveying mechanism 653, conveying rollers 656 near the recording media feeding mechanisms 221, respectively. When any one of the recording media feeding mechanisms 221 feeds a recording medium, the recording media conveying mechanism 653 conveys the recording medium to the recording media discharge section 655.

The image forming apparatus includes a secondary transfer roller 630a in a position along the recording media conveying mechanism 653 and opposed to the driven roller 630 across the transfer belt 12. The image forming apparatus includes registration rollers 658 in a position before the driven roller 630 and the secondary transfer roller 630a in a conveying direction.

The registration rollers 658 deliver the recording medium P to between the transfer belt 12 and the secondary transfer roller 630a serving as transfer units at timing synchronizing with a transfer operation, which is an operation for transferring an image formed by a developer onto a recording medium, by the transfer belt 12 and the secondary transfer roller 630a. The secondary transfer roller 630a transfers, while nipping the recording medium P delivered from the registration rollers 658 between the secondary transfer roller 630a and the transfer belt 12 on the driven roller 630, a visible image formed by the developer, which is transferred onto the transfer belt 12, onto the recording medium P and prints the visible image. In this way, the registration rollers 658 convey, in synchronization with the transfer operation of the image forming unit 220, the recording medium P to the image forming unit 220 having the transfer belt 12 and the secondary transfer roller 630a.

The image forming apparatus includes a heating and fixing device for heat fixing in a position further on a downstream side than the secondary transfer roller 630a of the recording media conveying mechanism 653. The heating and fixing device includes a metal roller, a fixing roller 645, a fixing belt laid over the metal roller and the fixing roller 645, and a pressing roller 646 that is set in contact with the fixing roller 645 across the fixing belt. The pressing roller 646 includes a heating device such as a heater lamp in the inside thereof.

The heating and fixing device nips, with the fixing roller 645 and the pressing roller 646, the recording medium P having the developer transferred thereon and heats and presses the recording medium P while conveying the same. When the recording medium P is heated and pressed, the developer is fixed on the recording medium P. The image forming apparatus includes a recording media discharge roller 661 at a terminal end of the recording media conveying mechanism 653.

The image forming apparatus includes, upstream in the recording media conveying direction of the nip formed by the fixing roller 645 and the pressing roller 646 of the heating and fixing device, an inlet guide 10 that guides a sheet to the nip.

The image forming apparatus may include an automatic duplex unit (hereinafter referred to as ADU) 222 in the apparatus main body 601. The ADU 222 is set to couple a sub-conveying path 662, which is a path for conveying the recording medium P in the ADU 222, to the terminal end of the recording media conveying mechanism 653 and an inlet to the registration rollers 658. The sub-conveying path 662 branches from a downstream side of the recording media conveying mechanism 653 with respect to the image forming unit 220 (the terminal end of the recording media conveying mechanism 653) and merges into an upstream side of the recording media conveying mechanism 653 with respect to the image forming unit 220 (an upstream side position of the registration rollers 658).

The sub-conveying path 662 reverses the front and the back of the recording medium P for duplex printing. The image forming apparatus includes recording media feeding rollers 663, 664, and 665 in the sub-conveying path 662. The ADU 222 feeds backward the recording medium P conveyed to the recording media discharge section 655 by the image forming unit 220, conveys the recording medium P through the sub-conveying path 662, and merges the recording medium P into the recording media conveying mechanism 653 on the upstream side of the image forming unit 220. When the recording medium P is conveyed in this way, the front and the back of the recording medium P are reversed.

After the recording medium P returned to the upstream side of the image forming unit 220 by the sub-conveying path 662 is merged into the recording media conveying mechanism 653, the image forming apparatus delivers, while synchronizing with the transfer operation of the image forming unit 220 using the registration rollers 658, the recording medium P into a transfer position where the transfer belt 12 and the secondary transfer roller 630a are in contact with each other. In this way, the image forming apparatus transfers a visible image on the transfer belt 12 onto the rear surface of the recording medium P as well to thereby print the visible image.

When the duplex printing is designated by, for example, an operation panel 724 provided in the apparatus main body 601 or a computer or the like connected to the apparatus main body 601 through a network, the sub-conveying path 662 of the ADU 222 changes to a state for performing an action for reversing the front and the back of the recording medium P.

Devices additionally provided in the image forming apparatus are explained below. The image forming apparatus includes a pair of the recording media cassettes 650 as feeding sources of recording media. The apparatus main body 601 may include a trio or more of recording media cassettes 650. Besides, although not shown in the figure, a manual-feed recording media feeding mechanism (hereinafter referred to as SFB) and a large-capacity recording media feeder (hereinafter referred to as LCF), which is a recording media feeding mechanism that can store several thousands recording media in a stacked state, can also be provided. The image forming apparatus includes the SFB and the LCF in the apparatus main body 601 such that paths of the SFB and the LCF for feeing recording media merge into the recording media conveying mechanism 653.

The image forming apparatus may include a recording media type sensor 223 in the apparatus main body 601. The recording media type sensor 223 is provided in a position on the upstream side of the recording media conveying mechanism 653 with respect to the image forming unit 220 and further on the upstream side than the registration rollers 658. The recording media type sensor 223 detects a recording media type of the recording medium P to be conveyed. As the recording media type sensor 223, for example, a publicly-known sensor that determines a type of the recording medium P by detecting the thickness and the light transmittance of the recording medium P can be used.

When the SFB and the LCF are set, the recording media type sensor 223 is set further on the downstream side than a merging point of the recording media feeding paths from the SFB and the LCF and the recording media conveying mechanism 653. By arranging the recording media type sensor 223 in this way, it is possible to detect, with a singularity of the recording media type sensor 223, types of the recording media P conveyed on the recording media conveying mechanism 653 from all the feeding sources of recording media.

Inlet Guide

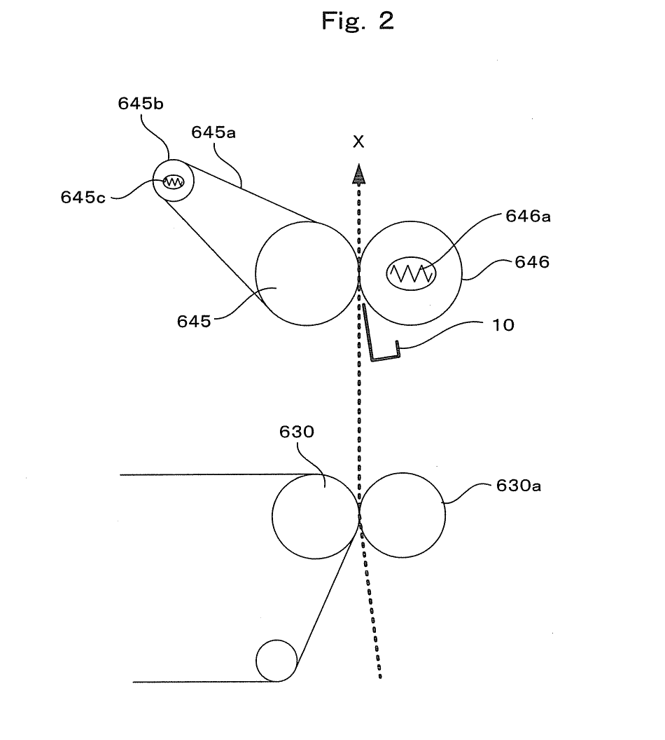

FIG. 2 is a diagram of a position of the inlet guide 10 according to this embodiment. The heating and fixing device includes the fixing roller 645 and the pressing roller 646 that is set in contact with the fixing roller 645 and has a heater lamp 646a in the inside thereof.

A fixing belt 645a is laid around the fixing roller 645 and a metal roller 645b. The metal roller 645b has a heater lamp 645c in the inside thereof.

As indicated by an arrow X, the image forming apparatus conveys a recording medium to the heating and fixing device through between the driven roller 630 and the secondary transfer roller 630a.

The image forming apparatus includes the inlet guide 10 upstream in the recording media conveying direction X of the nip formed by the fixing roller 645 and the pressing roller 646 not to come into contact with the fixing roller 645 and the pressing roller 646.

In other words, the image forming apparatus includes the inlet guide 10 further downstream in the recording media conveying direction X than a nip formed by the driven roller 630 and the secondary transfer roller 630a and upstream in the recording media conveying direction X of the nip formed by the fixing roller 645 and the pressing roller 646.

The recording medium comes into contact with the inlet guide 10 and changes a course thereof to a direction of the nip formed by the fixing roller 645 and the pressing roller 646. Therefore, the image forming apparatus includes the inlet guide 10 on the opposite side of the direction to which the course is changed in the recording media conveying direction X.

The inlet guide 10 is formed of a plate of metal such as stainless steel and coated with fluorine resin. Specifically, the inlet guide 10 has, on the surface thereof, a plated layer of nickel (Ni) containing 15 volume % or more of PTFE (polytetrafluoro-ethylene). If the content of PTFE is smaller than 15 volume %, the developer adheres to the inlet guide 10 and sets because of the heat of the heating and fixing device, and it becomes difficult to clean the inlet guide 10.

The thickness of the nickel plated layer is usually equal to or larger than 5 μm and equal to or smaller than 6 μm. The inlet guide 10 may be coated with PFA (tetrafluoroethylene-perfluoroalkyl vinyl ether copolymer) instead of the nickel plated layer.

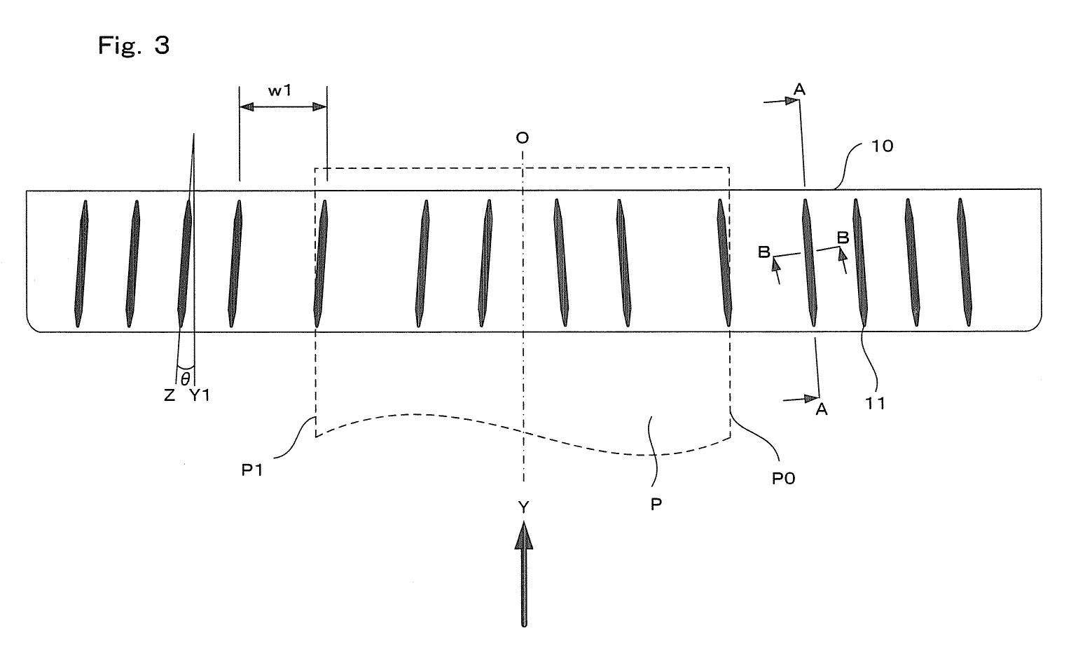

FIG. 3 is a top view of the inlet guide 10 according to this embodiment. As shown in FIG. 3, the inlet guide 10 has plural ribs 11 on a surface that comes into contact with a recording medium. The inlet guide 10 has the plural ribs 11 line symmetrical to each other with respect to a center line O of the inlet guide 10. The center line O is located in the center in the width direction of a recording medium conveyed by the image forming apparatus. Therefore, the ribs 11 prevent the recording medium from shifting in a direction perpendicular to a recording media conveying direction Y indicated by an arrow.

The ribs 11 are arranged such that the width between a pair of the ribs 11 in positions line symmetrical to each other with respect to the center line O is reduced toward the recording media conveying direction Y. In other words, the ribs 11 incline to an inner side in the recording media conveying direction Y toward the center line O.

The ribs 11 are arranged, concerning a size of each of recording medium treated by the image forming apparatus, in positions that come into contact with sides P0 and P1 of the recording medium in the recording media conveying direction Y. Therefore, the recording-medium does not bend to an outer side when the recording medium comes into contact with the inlet guide 10.

The inlet guide 10 further has a plurality of the ribs 11 on an inner side of the ribs 11 that come into contact with the sides P0 and P1 in the recording media conveying direction Y. Therefore, the recording medium does not bend to an inner side when the recording medium comes into contact with the inlet guide 10.

Width w1 between each of the ribs 11 and the rib 11 closest thereto is desirably equal to or smaller than 40 mm. If the width w1 is larger than 40 mm, the recording medium may bend. When the recording medium comes into contact with a plane portion of the inlet guide 10 because of the bend, soiling may occur on the rear surface of the recording medium.

A tilt angle θ of each of the ribs 11, i.e., an acute angle formed by a center line Z in a longitudinal direction of the ribs 11 and a straight line Y1 parallel to the recording media conveying direction Y is equal in the ribs 11 located in positions line symmetrical to each other with respect to the center line O. It is desirable that the tilt angle θ is equal in all the ribs 11.

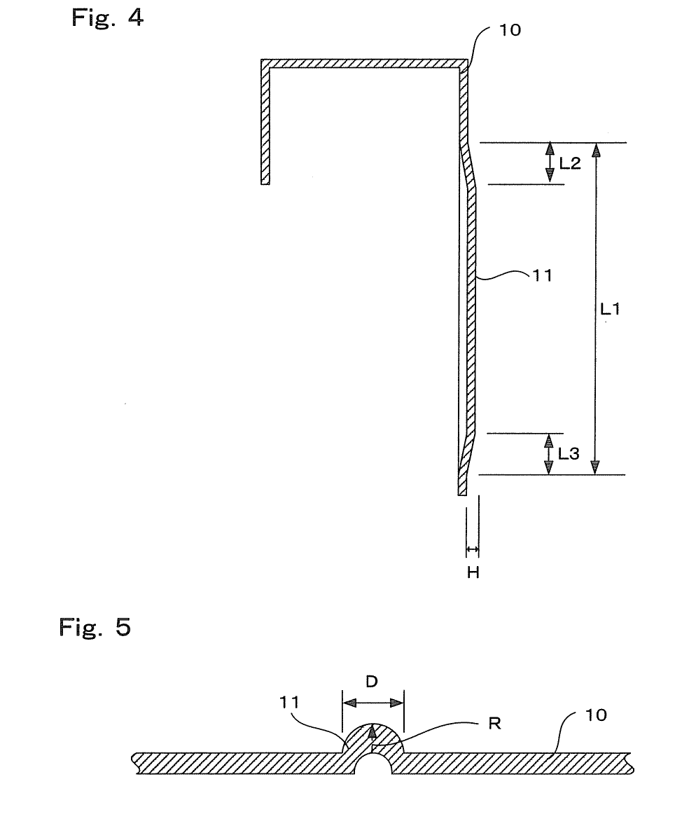

FIG. 4 is a sectional view of the inlet guide 10 along an A-A line in FIG. 3. As shown in FIG. 4, the rib 11 is formed in a streamline shape long in the recording media conveying direction Y. The rib 11 has inclined portions L2 and L3 at both ends in the longitudinal direction.

It is desirable that total length L1 in the longitudinal direction of the rib 11 is equal to or larger than 25 mm and equal to or smaller than 35 mm, lengths L2 and L3 of the inclined portions are equal to or larger than 2 mm and equal to or smaller than 6 mm, and height H of the rib 11 is equal to or larger than 0.3 mm and equal to or smaller than 1.0 mm.

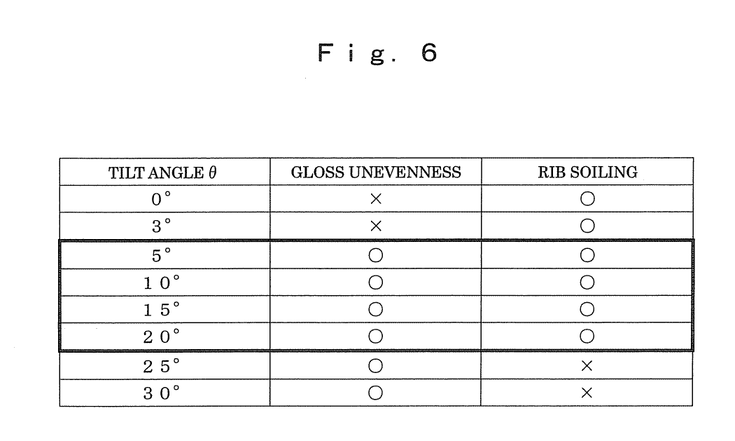

FIG. 5 is a sectional view of the inlet guide 10 along a B-B line in FIG. 3. As shown in FIG. 5, the rib 11 is formed in a semicircular shape in section. It is most desirable that sectional width D of the rib is 1 mm and a radius R of the section is 0.5 mm.

FIG. 6 is a table of ranges of the tilt angle θ of the ribs 11. As shown in FIG. 6, gloss unevenness occurs if the tilt angle θ of the ribs 11 is smaller than 5°. If the tilt angle θ of the ribs 11 exceeds 20°, a developer adheres to the ribs 11 and sets and lib soiling occurs. Therefore, the tilt angle θ is desirably equal to or larger than 5° and equal to or smaller than 20°.

As explained above, the image forming apparatus according to this embodiment includes the inlet guide 10 having the ribs 11 inclining to the inner side in the recording media conveying direction. Therefore, there is an effect that gloss unevenness does not occur and rib soiling does not occur either.

Although exemplary embodiments of the present invention have been shown and described, it will be apparent to those having ordinary skill in the art that a number of changes, modifications, or alterations to the invention as described herein may be made, none of which depart from the spirit of the present invention. All such changes, modifications, and alterations should therefore be seen as within the scope of the present invention.

What is claimed is:

1. An image forming apparatus comprising:
an image forming unit that forms a developer image on an image bearing member;
a transfer unit that transfers the developer image onto a recording medium;
a heating and fixing device that fixes the developer image, which is transferred onto the recording medium by the transfer unit, on the recording medium; and
an inlet guide that is arranged upstream in a recording media conveying direction of a nip formed by a fixing roller and a pressing roller of the heating and fixing device and has, on a recording media contact surface thereof, plural ribs inclining to a further inner side farther toward a recording media conveying direction.

2. The apparatus according to claim 1, wherein the plural ribs are arranged line symmetrical to each other with respect to a center line in width direction of a recording medium to be conveyed.

3. The apparatus according to claim 1, wherein an acute angle formed by center lines in a longitudinal direction of the plural ribs and a straight line parallel to a center line in width direction of a recording medium to be conveyed is equal to or larger than 5° and equal to or smaller than 20°.

4. The apparatus according to claim 1, wherein the inlet guide includes, concerning each size of a recording medium to be conveyed, the plural ribs in positions that come into contact with two sides in the recording media conveying direction of the recording medium.

5. The apparatus according to claim 4, wherein the inlet guide further includes plural ribs on an inner side of the plural ribs.

6. The apparatus according to claim 1, wherein width between each of the ribs and the rib closest to the rib is equal to or smaller than 40 mm.

7. The apparatus according to claim 1, wherein height of the ribs is equal to or larger than 0.3 mm and equal to or smaller than 1.0 mm.

8. The apparatus according to claim 1, wherein total length in a longitudinal direction of the ribs is equal to or larger than 25 mm and equal to or smaller than 35 mm.

9. The apparatus according to claim 1, wherein the inlet guide is coated with fluorine resin.

10. The apparatus according to claim 9, wherein the fluorine resin is nickel containing PTFE (polytetrafluoro-ethylene) or PFA (tetrafluoroethylene-perfluoroalkyl vinyl ether copolymer).

11. An inlet guide that is arranged upstream in a recording media conveying direction of a nip formed by a fixing roller and a pressing roller of an image forming apparatus for heating and pressing a recording medium having a developer transferred thereon and has, on a recording media contact surface thereof, plural ribs inclining to a further inner side farther toward a recording media conveying direction.

12. The inlet guide according to claim 11, wherein the plural ribs are arranged line symmetrical to each other with respect to a center line in width direction of a recording medium to be conveyed.

13. The inlet guide according to claim 11, wherein an acute angle formed by center lines in a longitudinal direction of the plural ribs and a straight line parallel to a center line in width direction of a recording medium to be conveyed is equal to or larger than 50 and equal to or smaller than 20°.

14. The inlet guide according to claim 11, wherein the inlet guide includes, concerning each size of a recording medium to be conveyed, the plural ribs in positions that come into contact with two sides in the recording media conveying direction of the recording medium.

15. The inlet guide according to claim 14, wherein the inlet guide further includes plural ribs on an inner side of the plural ribs.

16. The inlet guide according to claim 11, wherein width between each of the ribs and the rib closest to the rib is equal to or smaller than 40 mm.

17. The inlet guide according to claim 11, wherein height of the ribs is equal to or larger than 0.3 mm and equal to or smaller than 1.0 mm.

18. The inlet guide according to claim 11, wherein the inlet guide is coated with fluorine resin.

19. A recording media conveying method for an image forming apparatus, the method comprising:
arranging, upstream in a recording media conveying direction of a nip formed by a fixing roller and a pressing roller for heating and pressing a recording medium having a developer transferred thereon, an inlet guide having, on a recording media contact surface thereof, plural ribs inclining to a further inner side farther toward a recording media conveying direction; and
bringing the recording medium into contact with the ribs of the inlet guide to guide the recording medium to the nip.

20. The method according to claim 19, further comprising arranging the plural ribs such that an acute angle formed by center lines in a longitudinal direction of the plural ribs and a straight line parallel to a center line in width direction of a recording medium to be conveyed is equal to or larger than 5° and equal to or smaller than 20°.
